(19) United States
(12) Patent Application Publication
(10) Pub. No.: US 2023/0134321 A1
(43) Pub. Date: May 4, 2023

(54) PICTURE FRAME WITH SELECTIVE SOURCE ILLUMINATION

(71) Applicant: Andrew Carr, Somerville, MA (US)

(72) Inventor: Andrew Carr, Somerville, MA (US)

(21) Appl. No.: 17/517,264

(22) Filed: Nov. 2, 2021

(51) Int. Cl. A47G 1/06; F21V 3/00

(52) U.S. Cl. CPC A47G 1/0622; F21V 3/00; F21Y 2115/10

(57) ABSTRACT

An illuminated frame for displaying images includes a translucent surface having at least one edge, and a light source. The edge defines an enclosed area and the image is within the enclosed area. Both the translucent surface and the image are within a line of sight of the observer that is normal to the enclosed area. The translucent surface partitions the light source from the enclosed area, whereby the enclosed area and the image are illuminated by light that passes from the light source through the translucent surface.

### BACKGROUND

When artwork is being shown, the intent is to show the artwork with the best light possible to enhance the viewing experience. Most artwork is illuminated from light that is present in the room (e.g., ambient light). Ambient light can come from a variety of sources, such as overhead fluorescent or incandescent lights. Often this type of lighting does not provide lighting that is consistent over time or that evenly illuminates the artwork without interference caused by, for example, shadows. Many galleries, displaying artwork for the consumers’ evaluation have dark walls and no windows to preclude daylight from diminishing the artistic presentation.

Paintings are often hung along with specific lighting fixtures intended to illuminate the painting so as to draw attention to the painting and ensure that the painting is displayed in proper lighting. Spot lighting is typically used to enhance the artwork, but often requires attaching a light near or on one a side of the frame. Dimmer controls are often provided to suit viewers’ preference.

However, the use of supplemental light sources is often cumbersome, bulky, and can distract from the artwork. For example, the appearance of the artwork can vary with frequencies of light to which it is exposed, which can be significantly different from those under which it was created or intended to be viewed by the artist. The artist is typically limited to the appearance of the artwork by external lighting over which there is little or no control by the artist.

Therefore, a need exists for a source that is convenient and reliable, while providing illumination that is sufficient and of the appropriate wavelength to properly light the artwork as it was intended to be viewed by the artist, particularly in a variety of color and behavioral schemes.

### SUMMARY

The present invention relates to framing for artwork and, more particularly, to an illuminated frame backlit that includes a light source (e.g., LEDs (light-emitting diodes)) to enhance the appearance of the artwork.

In one embodiment, an illuminated frame to display an image includes a translucent surface having at least one edge, wherein the edge defines an enclosed area, and the translucent surface is visible to an observer of the enclosed area, wherein the entirety of the translucent surface and the enclosed area are within a line of sight of the observer that is normal to the enclosed area. Additionally, the illuminated surface includes a light source (e.g., a light source that includes a plurality of component color wavelengths), wherein the translucent surface partitions the light source from the enclosed area, and whereby the enclosed area is illuminated by light that passes from the light source through the translucent surface.

This invention has many advantages. For example, artwork can be illuminated under the strict control of the artist who can, by virtue of the invention, complement the artwork with a light source that can be a component of the work such as by varying in component color wavelengths, thereby also enhancing the appearance of the work. For example, lights of different colors at various parts of the illuminated frame can show patterns and/or cast different colors onto the artwork. The illuminated frame can also include flashing lights and changes in color that can change the appearance of the artwork within the frame. In other embodiments, the illuminated frame of the invention can be tuned in a manner that adheres most closely to the original artistic intention or by complementing the artwork with an appearance of the frame that enhances the overall visual appeal. The illuminated frame can, alternatively, enhance and/or restore the appearance of artwork to that originally intended compared to external lighting (e.g., overhead lighting), and can be used to display artwork in ambient environment that is poorly lit or lacks lighting altogether (e.g., outdoors, at night).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a front view of one embodiment of an illuminated frame configured to display an image showing a power source and a translucent surface having at least one edge, wherein the edge defines an enclosed area and the translucent surface is visible to an observer of the enclosed area, and wherein dotted and dashed lines represent different colors on two dimensional surface bordered by the edge.

FIG. 2 is a perspective view of the embodiment of an illuminated frame of the invention of FIG. 1.

FIG. 3 is a cross-section, shown in perspective, of the illuminated frame of FIGS. 1 and 2.

FIG. 4A is a cross-sectional view of the illuminated frame of FIG. 3.

FIG. 4B is an exploded view of the embodiment of FIG. 4A.

FIG. 5 is an exploded view, in perspective of a back portion of the illuminated frame of FIG. 1-4B.

FIG. 6A is a front view of another embodiment of an illuminated frame of the invention, wherein the frame is in the shape of an octagon, and displaying an artwork bordered by a translucent surface having at least one edge, wherein the edge defines an enclosed area and the translucent surface is visible to an observer of the enclosed area.

FIG. 6B is a front view of the embodiment of the illuminated frame of FIG. 6A,, wherein the appearance of the artwork is modified by limiting the wavelength of light from the translucent surface to only one of the component wavelengths of emitted from the translucent surface to create the image that appears in FIG. 6A.

### DETAILED DESCRIPTION

The features and other details of the invention, either as steps of the invention or as combinations of parts of an invention, will now be more particularly described and pointed out in the claims. It will be understood that the particular embodiments of the invention are shown by way of illustration and not as to limitations of the invention. The principal features of this invention can be employed in various embodiments without departing from the scope of the invention. It will also be understood that the same number appearing in different drawings represents the same item.

The invention generally is directed to an illuminated frame to display an image comprising translucent surface (e.g., conical translucent surface, glass translucent surface, plastic translucent surface) and light source. The illuminated frame is useful in enhancing presentation of artwork and providing artwork lighting without attaching external lighting.

A description of example embodiments follows.

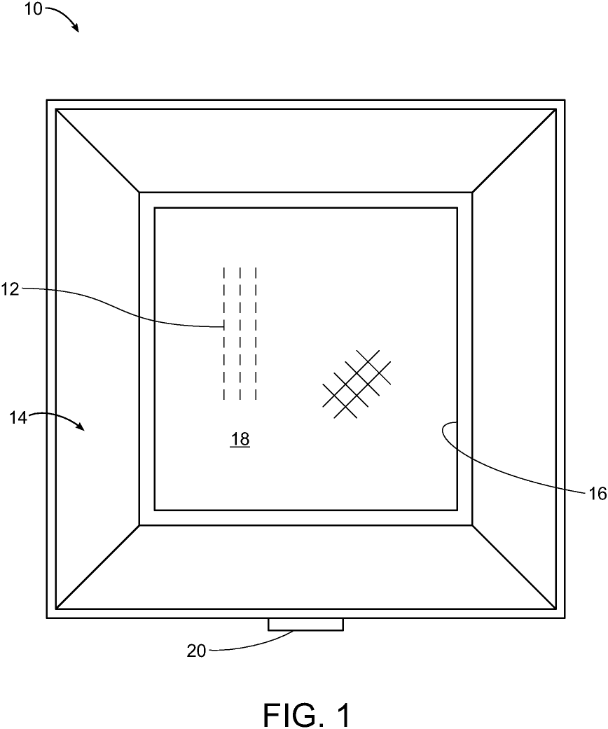

One embodiment of the invention is shown in FIG. 1. As shown therein, a front view of an illuminated frame 10 to display an image 12 includes translucent surface 14 having at least one edge 16, wherein edge 16 defines enclosed area 18, and wherein image 12 and translucent surface 14 are visible to an observer of enclosed area 18, and image 12 is within a line of sight of the observer that is normal to the plane of enclosed area 18. Image 12 can be two dimensional and coplanar with or parallel to a plane defined by edge 16. In other embodiments, image 12 is not two-dimensional. Image 12 can include a plurality of colors, as represented in FIG. by dashed lines, indicating blue, and solid lines, indicating red. Edge 16 of the translucent surface 14 defines the shape of enclosed area 18. In the embodiment of FIG. 1, enclosed area is a square. It is to be understood, however, that enclosed area 18 can have other shapes, such as any polygon having at least three edges or sides, wherein translucent surface includes at least three planar components, or can be a circle, an oval, or any other shape. In one embodiment, illuminated frame 10 includes power source 20 that provides power to illuminate translucent surface 14 and, therefore, image 12. Alternatively, power necessary to illuminate translucent surface 14 and image 12 can be provided from an external source, not shown. Power source 20 can be, for example, a battery, a storage capacitor, or a solar cell). In one embodiment, solar cells can be employed to charge internal batteries when there is sufficient ambient lighting and supplemental frame lighting is not required.

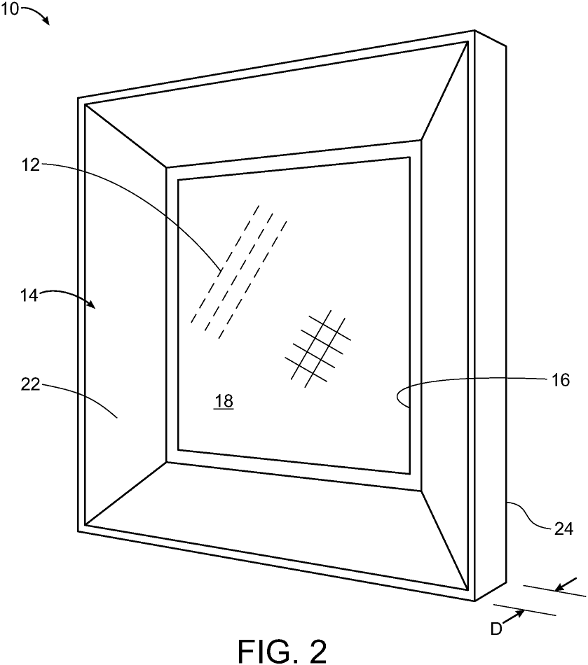

FIG. 2 is a perspective view of illuminated frame 10 of FIG. 1, showing that illuminated frame 10 has a beveled appearance, wherein translucent surface 14 is at a positive angle relative to a plane defined by enclosed area 18. In various embodiments, the positive angle can be in a range of between about 30 and about 90 degrees. Also, while, as shown in FIG. 2, translucent surface 14 includes component planar surfaces 22 that meet at corners to thereby define enclosed area 18 at edges 16, it is to be understood that translucent surface 14 need not be planar, such as when enclosed area 18 has a curved perimeter. The positive angle of translucent surface 14 to enclosed area 18 ensures that image 12 is illuminated by light transmitted to translucent surface 14, and that translucent surface 14 is visible to an observer viewing image 12 at angle normal to the planed defined by edges 16. As a consequence of the angle of translucent surface14 to the plane defined by enclosed area 18, illuminated frame has a depth D at perimeter 24. The depth D of illuminated frame 10 at perimeter 24 can be, for example, in a range of between about 2 and about 5.

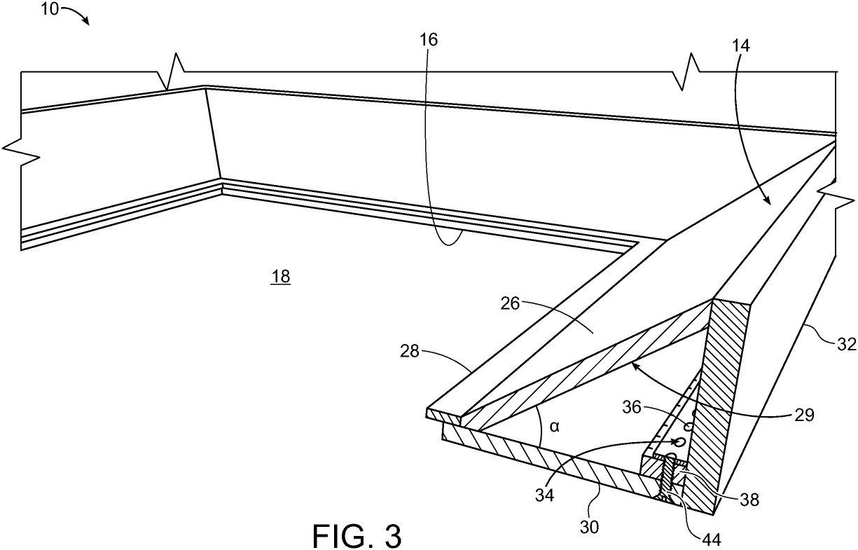

FIG. 3 is cross-section, shown in perspective, of illuminated frame 10 of FIGS. 1 and 2. As shown in FIG. 3, illuminated frame 10 includes translucent surface 14 defined, at least in part, by translucent border panels 26. Translucent border panels 26 are formed of a suitable material, such as glass, plastic, or acrylite. While translucent surface 14 is generally angled relative to a plane defined by edge 16, in one embodiment, translucent surface 14, includes translucent border piece 28, such as is shown in FIG. 3, which defines edge 16, wherein border piece 28 is not angled relative to the plane defined edge 16. In either case, the angle of translucent border panels 26 to the plane defined by edge 16 is represented in FIG. 3 by a. Border piece 28 can, optionally, be translucent, transparent, or opaque. Translucent border panels 26 and border pieces together constitute border panel assembly 29. Border piece 28 can, but need not be, of the same material of construction as that of translucent border panels 26.

Translucent border pieces 28 are supported by back panel 30 and side panels 32, as shown in FIG. 3. Back panel 30 is parallel to or coplanar with the plane defined by enclosed area 18. Back panel 30 and side panels are joined, by means known to those skilled in the art, such as glue and screws. In the embodiment shown in FIG. 3, back panel 30 and side panels 32 are joined at a right angle, although they can be joined at other angles. Materials of construction of back panel and side panel 32 are such as are known to be suitable to those skilled in the art and can include, for example, metal, such as steel, or wood.

Light source 34 is secured to at least one of back panel 30 and side panel 32 by means known to those skilled in the art. In one embodiment, light source 34 is secured to back panel 30 at the juncture of back panel 30 and side panels 32. In the embodiment shown in FIG. 3, light source is a strip of light that extends along at least a portion of the length of each side panel 32. Optionally, the strip of light can extend about a periphery of enclosed area 18. Light source 34 can either be filtered by appropriate means, not shown, to cause light emitted to be limited to specific color frequencies or, alternatively, light source 34 can be a composite of a plurality of colors that are selectively amplified or muted to change the apparent color emitted by light source 34. In a particular embodiment, shown in FIG. 3, light source 34 is an array of light-emitting diodes (LEDs) 36 (e.g., an array of red, green, and blue LED diodes). Other forms of suitable light source 34 include, for example, florescent, incandescent, or other light generating sources. In still other embodiments, light source 34 can include fiber optics, or light pipes.

Translucent surface 14 partitions light source 34 from enclosed area 18, whereby image 12 at enclosed area 18 is illuminated by light that passes from light source 34 through translucent surface 14. Light source 34 can be controlled by means known to those skilled in the art to cause selective distribution and temporal display of brightness and frequency of light from light source 34 to illuminate image 12. Illuminated frame 10 of the invention can also include a controller (not shown) (e.g., a microcontroller, remote controller, controlled by motion detection, controlled by a software program).

In one embodiment, not shown, illuminated frame 10 can include mirrors around the inside perimeter of side panels 32 of illuminated frame 10 to thereby cause light from light source 34 to be reflected back toward transparent border panels 26 for transmission to image 12. Light source 34 can be controlled by suitable means know in the art to thereby emit different color frequencies in a spatial or temporal distribution, or both, to thereby changed the appearance of image 12, depending on the colors making up image 12. Further, light source 34 can be linked to a microphone or sound sensor (not shown), to thereby control at least one of the distribution, timing, and frequency of light emitted. In one alternative embodiment, image 12 does not lie in a plane that is coplanar or parallel to a plane defined by edge 15. This may be the case if either edge 16 defined by translucent surface is not planar, or if image is three-dimensional. If image 12 is three-dimensional, light source 34 can be controlled to selectively cast shadows on image 12.

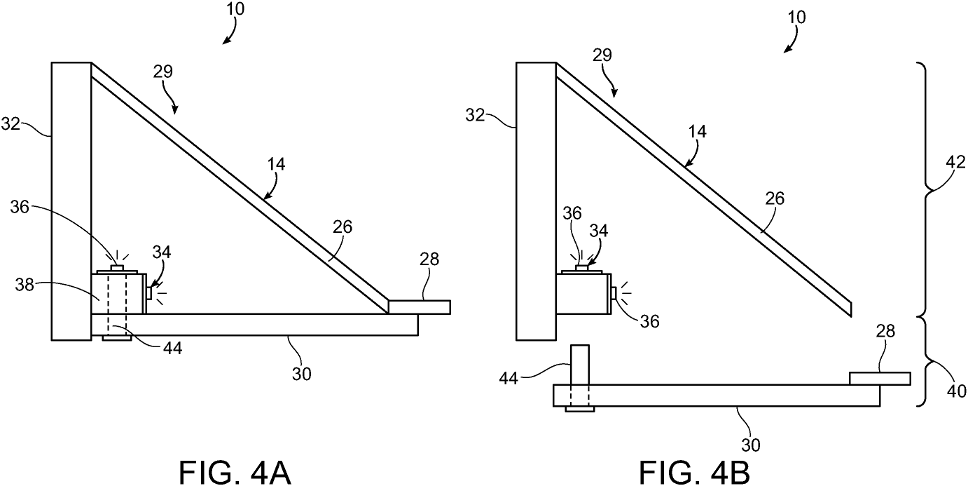

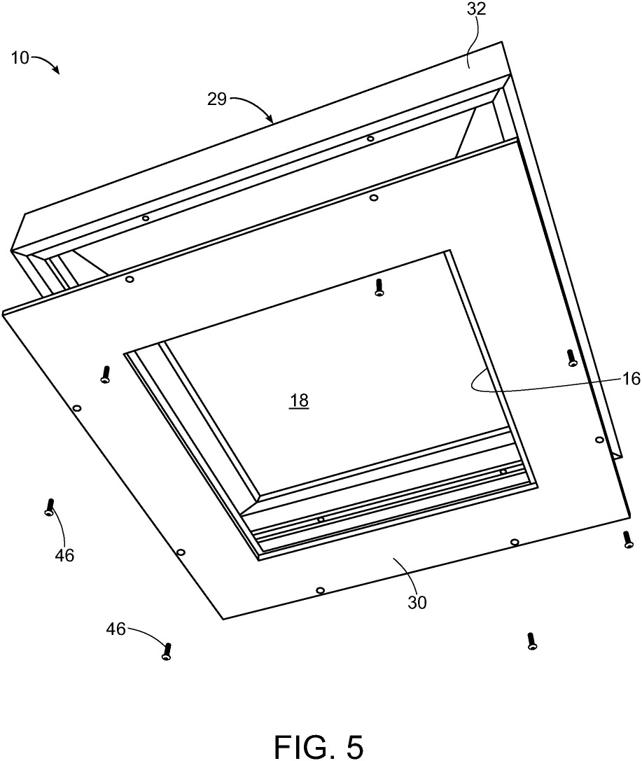

FIGS. 4A and 4B are cross-sectional, and partially exploded cross-sectional view, respectively, of illuminated frame 10 of FIGS. 1 through 3. As can be seen in FIG. 4A, light source 34 includes LEDs 36 arrayed along two surfaces of support. It is to be understood that different arrangements of LEDs can be employed in alternative embodiments of the invention. As can be seen in FIG. 4B, in one embodiment, border pieces 28 of border panel assembly 29 and back panel 30 can be separated as first unit 40 from translucent border panel 26, side panels 32, support 38, and LEDs 36, as second unit 42. Pins 44 link first unit 40 to second unit 42 at support 38.

FIG. 5 is an exploded view, in perspective, of a back portion of illuminated frame 10 of the invention, shown, in FIG. 1 through 4B. As can be seen in FIG. 5, back panel 30 is secured to side panels 32 by a suitable attachment mechanism, such as is known in the art. In the case of the embodiment shown in FIG. 5, the attachment mechanism are screws 46. Exemplary alternative attachment mechanisms include use of nuts and bolts, rivets, sewing or chemical fastening (e.g. adhesives).

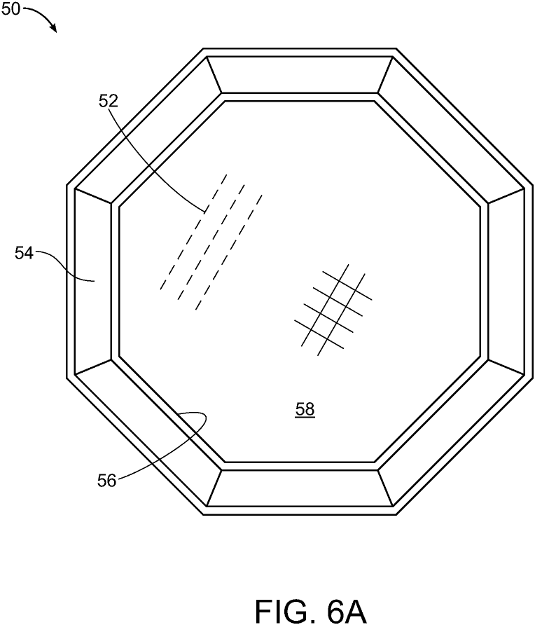

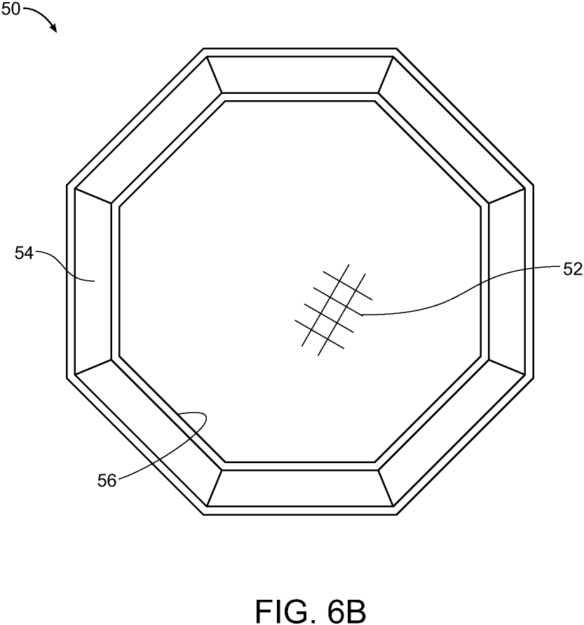

FIG. 6A is an example of another embodiment of the invention. In this embodiment, illuminated frame 50 includes image 52, translucent surfaces 54 having edge 56 defining enclosed area 58, all as described above, except that illuminated frame is shaped as an octagon. As shown therein, image 52 includes a plurality of colors, the different colors being indicated by the presence of dashed lines, representing one color, and solid lines, representing a different color. Under white light all of the colors can be seen. FIG. 6B is a representation of illuminated frame 50, wherein only select colors are transmitted through translucent surfaces 54, whereby only a portion of the colors of image 52 are visible.

### Equivalents

Those skilled in the art will recognize, or be able to ascertain using no more than routine experimentation, many equivalents to the specific embodiments of the invention described herein. Such equivalents are intended to be encompassed by the following claims.

1. An illuminated frame configured to display an image, comprising:
a) a translucent surface having at least one edge, wherein the edge defines an enclosed area, and the translucent surface is visible to an observer of the enclosed area, wherein an entirety of the translucent surface and the enclosed area are within a line of sight of the observer that is normal to the enclosed area; and
b) a light source, wherein the translucent surface partitions the light source from the enclosed area, whereby the enclosed area is illuminated by light that passes from the light source through the translucent surface.

2. The illuminated frame of claim 1, wherein the enclosed area is a polygon.

3. The illuminated frame of claim 1, wherein the enclosed area is a plane.

4. The illuminated frame of claim 3, wherein the line of sight of the observer is orthogonal to the plane defined by the enclosed area.

5. The illuminated frame of claim 4, wherein the translucent surface is conical.

6. The illuminated frame of claim 5, wherein the translucent surface has an angle relative to the plane of the enclosed area of between about 30 degrees to about 90 degrees.

7. The illuminated frame of claim 1, wherein the translucent surface includes at least three planar components.

8. The illuminated frame of claim 7, wherein the planar components define a surface having an angle relative to the enclosed area of between about 30 degrees to about 90 degrees.

9. The illuminated frame of claim 1, wherein the light source emits light in a plurality of colors.

10. The illuminated frame of claim 1, further including a circuit, whereby a distribution of colors of the light source is variable.

11. The illuminated frame of claim 10, wherein the distribution of colors of the light source changes over time.

12. The illuminated frame of claim 1, wherein the light source is a combination of LEDs.

13. The illuminated frame of claim 1, further including a planar surface defined by the enclosed area.

14. The illuminated frame of claim 13, wherein the planar surface defined by the enclosed area includes a distribution of colors formed by light from the light source which is selectively reflected.

15. The illuminated frame of claim 14, wherein an appearance of the planar surface depends upon the colors of the light source.

16. The illuminated frame of claim 1, further including a power control.

17. (canceled)

18. (canceled)

19. (canceled)

20. (canceled)

21. The illuminated frame of claim 1, further including a power source.

22. (canceled)

23. The illuminated frame of claim 1, wherein the translucent surface is glass or plastic.

24. The illuminated frame of claim 1, wherein the enclosed area is an image.

25. The illuminated from of claim 24, wherein the image is an artwork.
